(19) United States
(12) Patent Application Publication
(10) Pub. No.: US 2013/0190932 A1
(43) Pub. Date: Jul. 25, 2013

(54) SYSTEM AND METHOD FOR OPERATION OF AN HVAC SYSTEM TO ADJUST AMBIENT AIR TEMPERATURE

(71) Applicant: Daniel C. Schuman, Oregon, WI (US)

(72) Inventor: Daniel C. Schuman, Oregon, WI (US)

(21) Appl. No.: 13/355,086

(22) Filed: Jan. 20, 2012

(51) Int. Cl. G05D 23/00

(52) U.S. Cl. 700/278

(57) ABSTRACT

A system for the temporary adjustment of ambient temperature in an environment to improve the short term comfort of a user is also provided. The system includes an HVAC system including a unit to condition air, the HVAC system in operable communication with the environment to provide conditioned air, a thermostat in communication with the HVAC system, the thermostat adapted to measure the ambient temperature of the environment and to provide control instructions to the HVAC system, and a control module residing on the thermostat, the control module adapted to execute program parameters upon activation of a program execution button. A method for temporarily adjusting an ambient temperature of an environment regulated by an HVAC system is also provided.

### FIELD OF THE INVENTION

The present invention relates to heating, ventilation, and air conditioning (HVAC) systems. More specifically, the present invention relates to a system and method for the adjustment of ambient air temperature in an environment by operation of an HVAC control program.

### BACKGROUND

Thermostats and related programmable controls for an HVAC control system are generally known in the art. A thermostat is a component of an HVAC control system which can regulate the ambient temperature of an environment to be near a desired set point temperature. In addition, a thermostat may also include programmable controls for the HVAC system. For example, the thermostat may have one or more programmable settings which provide a desired ambient temperature target for a period of time. The period of time may further be associated with a specified day. This enables a user of a thermostat to input program settings which balance different factors. For example, the user may program the thermostat to balance comfort with the cost associated with HVAC system operation and associated energy usage. As such, the thermostat may be programmed to target a temperature which is more comfortable to the user during times while the user is present in the environment, and to target a temperature which is less comfortable to the user, but requires less HVAC system operation and subsequent operational expense, while the user is away from the environment.

However, known thermostats and related programmable controls for an HVAC control system have certain limitations. For example, in instances where a user desires to temporarily adjust the ambient temperature of an environment to improve the short term comfort of the user, the user generally has a limited number of system control options.

As a first option, the user may program a new set point temperature into the thermostat and place the system into a permanent hold to maintain the new set point temperature. However, by placing the system into a permanent hold, the thermostat will maintain the new set point temperature indefinitely. As such, once the user has attained the desired short term comfort, the user must reprogram the thermostat to remove the permanent hold. In addition, a permanent temporary hold of a manually adjusted temperature set point can result in unwanted additional expense, as the HVAC system will continue to operate until the permanent hold is removed. This can be well after the user has attained the desired short term comfort and/or the user leaves the environment controlled by the HVAC system.

As a second option, the user may change the thermostat program settings to target a new set point temperature for a specified period of time. However, by reprogramming the thermostat, the thermostat will continue to implement the new set point temperature in association with the specified period of time indefinitely. Once the user has attained the desired short term comfort, the user must again reprogram the thermostat set point temperature in association with the specified period of time.

As a third option, the user may manually adjust the temperature set point on the thermostat to target a new set point temperature. In certain thermostats and associated HVAC control systems, the manual adjustment of the temperature set point will result in the thermostat targeting the new set point temperature until the next scheduled event in the control system. Accordingly, the manual adjustment of the temperature set point effectively acts as a “temporary hold,” as the thermostat maintains the manually adjusted temperature set point until the thermostat is scheduled to change the temperature set point. However, while the user is not required to reprogram the thermostat once the user has attained the desired short term comfort, it may be necessary, as the next scheduled event could be hours or days from occurring. In addition, a prolonged “temporary hold” of the manually adjusted temperature set point can result in unwanted additional expense, as the HVAC system would continue to operate even after the user has attained the desired short term comfort and/or the user leaves the environment controlled by the HVAC system.

As a fourth option, many users and/or homeowners have difficulty adjusting programmable thermostats more complex than a manual adjustment of a current temperature setting. Often the users and/or homeowners will simply “set it and forget it,” or have someone else set the thermostat for them. The users and/or homeowners may then endure less than optimal temperatures and/or undesirable short term comfort until the next program change.

### SUMMARY OF THE DESCRIPTION

The present invention provides an HVAC control system which enables a user to initiate a temporary adjustment of the ambient temperature of an environment to improve the short term comfort of the user. The temporary adjustment may be initiated by manual activation of the control system. Further, the present invention provides for the control system to subsequently return to the prior programming once the desired ambient temperature or HVAC system operation time is reached. In addition, the present invention enables the control system to return to the prior programming without the need for the user to reprogram or readjust the HVAC control system once the user has attained the desired short term comfort.

A method for temporarily adjusting an ambient temperature of an environment regulated by an HVAC system is provided. The method includes the steps of activating a control program through actuation of a program execution switch, interrupting a thermostat control event in place at the time of activating the control program, measuring the ambient temperature in the environment regulated by the HVAC system through a thermostat, generating a temporary temperature set point by combining the ambient temperature with a temperature offset, implementing the temporary temperature set point as a target temperature on the thermostat, activating the HVAC system to heat or cool the environment, measuring an adjusted ambient temperature in the environment regulated by the HVAC system through the thermostat, determining whether the adjusted ambient temperature equals the temporary temperature set point, repeating the step of measuring the adjusted ambient temperature and determining whether the adjusted ambient temperature equals the temporary temperature set point if the adjusted ambient temperature does not equal the temporary temperature set point, and restoring the scheduled thermostat control event and terminating the method if the adjusted ambient temperature does equal the temporary temperature set point.

In addition, a method of temporarily adjusting an ambient temperature of an environment regulated by an HVAC system is provided. The method includes the steps of activating a control program through actuation of a program execution switch, interrupting a scheduled thermostat control event in place at the time of activating the control program, activating the HVAC system to heat or cool the environment, determining if an amount of time remaining in a timer is greater than zero, reducing the amount of time remaining in a timer by a desired increment if the amount of time remaining in the timer is greater than zero, repeating the determining and reducing steps if the amount of time remaining in the timer is greater than zero, and restoring the scheduled thermostat control event and terminating the method if the amount of time remaining in the timer is not greater than zero.

A system for the temporary adjustment of ambient temperature in an environment to improve the short term comfort of a user is also provided. The system includes an HVAC system including a unit to condition air, the HVAC system in operable communication with the environment to provide conditioned air, a thermostat in communication with the HVAC system, the thermostat adapted to measure the ambient temperature of the environment and to provide control instructions to the HVAC system, and a control module residing on the thermostat, the control module adapted to execute program parameters upon activation of a program execution button. The program parameters include a first program parameter adapted to interrupt a thermostat control event which is in place at the time of activation of the program execution button, a second program parameter adapted to generate a temporary temperature set point by combining a reference temperature with a temperature offset, a third program parameter adapted to implement the temporary temperature set point as a target temperature on the thermostat, a fourth program parameter adapted to activate the HVAC system to heat or cool the environment, a fifth program parameter adapted to measure an adjusted ambient temperature in the environment, a sixth program parameter adapted to determine whether the adjusted ambient temperature equals the temporary temperature set point, a seventh program parameter adapted to repeat the measurement of the adjusted ambient temperature in the environment and the determination as to whether the adjusted ambient temperature equals the temporary temperature set point if the adjusted ambient temperature does not equal the temporary temperature set point, and an eighth program parameter adapted to restore the thermostat control event and terminate the program parameters if the adjusted ambient temperature does equal the temporary temperature set point.

### BRIEF DESCRIPTION OF THE DRAWINGS

FIG. 1 is an isometric view of a heating, ventilation and air conditioning (HVAC) system with portions provided in cut-away to illustrate certain components and which incorporates one or more embodiments of an HVAC control program adapted to provide for the short term adjustment of ambient air temperature.

FIG. 2 is an elevation view of an embodiment of a thermostat for use with the HVAC system of FIG. 1.

FIG. 3 is an elevation view of an alternate embodiment of a thermostat for use with the HVAC system of FIG. 1.

FIG. 4A is a flow diagram of a portion of an embodiment of an HVAC control program adapted to provide for the short term adjustment of ambient air temperature for use with the HVAC system of FIG. 1.

FIG. 4B is a flow diagram of a second portion of an embodiment of an HVAC control program illustrated in FIG. 4A adapted to provide for the short term adjustment of ambient air temperature for use with the HVAC system of FIG. 1.

FIG. 5 is a flow diagram of an alternate embodiment of an HVAC control program adapted to provide for the short term adjustment of ambient air temperature for use with the HVAC system of FIG. 1.

### DETAILED DESCRIPTION

The invention illustrated in the Figures and disclosed herein is generally directed to an HVAC system 100, and a control system 500, 600 and method for the adjustment of ambient air temperature in an environment to improve the short term comfort of a user. For ease of discussion and understanding, the following detailed description will at times refer to the operation of an HVAC control program to improve the short term comfort of a user in association with a heat mode or heat cycle. It should be appreciated that “heat mode” or “heat cycle” is provided for purposes of illustration, and the HVAC control program to improve the short term comfort of a user may be used in association with any number of HVAC control situations, including, but not limited to, a cooling mode or cooling cycle. In addition, it should be appreciated that temperatures measured, targeted or otherwise used in association with HVAC system 100 or control system 500, 600 may be in Fahrenheit units, Celsius units, or any other suitable temperature measurement unit.

It should be appreciated that the term “short term comfort” of a user is directed to include how comfortable or physically content a user is in association with the ambient temperature of an environment regulated by an HVAC system at any given moment in time. The term “short term comfort” may generally be a subjective level of physical comfort based upon the ambient temperature felt by a user at a given moment and which may be unique to one or more different users. “Short term comfort” may also change from moment to moment depending upon a number of different factors, for example, but not limited to, the ambient temperature outside of the environment regulated by an HVAC system, such as the temperature outdoors or outside, different outdoor weather, different outdoor seasonal conditions, and/or the clothing worn by a user on a given day or at a given moment. The “short term comfort” of a user may also change even though the temperature of an environment regulated by an HVAC system has not changed. For example, a user may have a different “short term comfort” in a 65° F. (sixty-five degrees Fahrenheit) room of a building during the summertime, where the outdoor temperature is 102° F. (one hundred and two degrees Fahrenheit), compared to during the wintertime, where the outdoor temperature is 32° F. (thirty-two degrees Fahrenheit).

It should also be appreciated that the short term comfort of a user can be “improved” by either raising or lowering the ambient temperature of an environment regulated by an HVAC system. The associated “improvement” is generally based upon the subjective short term comfort of the user. For example, should a user feel cold in an environment regulated by an HVAC system, the short term comfort of the user could be “improved” by increasing the temperature in the environment. As another example, should a user feel warm in an environment regulated by an HVAC system, the short term comfort of the user could be “improved” by decreasing the temperature in the environment.

In addition, it should be appreciated that a “control event” may be any scheduled or manually entered HVAC system control program, set point, or state. For example, a program entered into a thermostat targeting a temperature of 65° F. (sixty-five degrees Fahrenheit) from 8:00 am to 2:00 pm may be a control event. As another example, a thermostat permanent hold of a target temperature entered by a user may be a control event. Accordingly, a control event may include any program or settings controlling an HVAC system. The associated “next control event” may include a manual setting or program or scheduled program which follows the present control event. In addition, a “scheduled” control event may include any control program, manually entered set point, or non-programmable system state which will occur at a certain time, day, and/or date. For example, in association with one or more examples of embodiments of control system 500, 600 disclosed herein, control system 500, 600 may begin operation during a first control event, but may complete operation during a second control event. At any time before, during and after control system 500, 600 is in operation, the first control event and/or second control event may be termed a “scheduled control event.”

It should also be appreciated that an “HVAC system” may include a ducted system, an unducted system, or any other suitable system for providing conditioned air. For example, an HVAC system may include, but is not limited to, a forced air system, an electrical base board heat system, hydronic heating or cooling, a window heat or air conditioning unit, or a free standing heating or air conditioning unit.

In addition, it should be appreciated that “conditioned air” may include any suitable treatment or adjustment to air. For example, conditioned air may include, but is not limited to, heated air, cooled air, cleaned air, humidified air, dehumidified air, and/or filtered air. A “conditioning unit” may include any device or equipment which conditions air. For example, a conditioning unit may include, but is not limited to, a heat unit, a cooling unit, an air cleaning unit, a humidifier, a dehumidifier, an air filter, and/or any other device which may improve or enhance indoor air quality (“IAQ”).

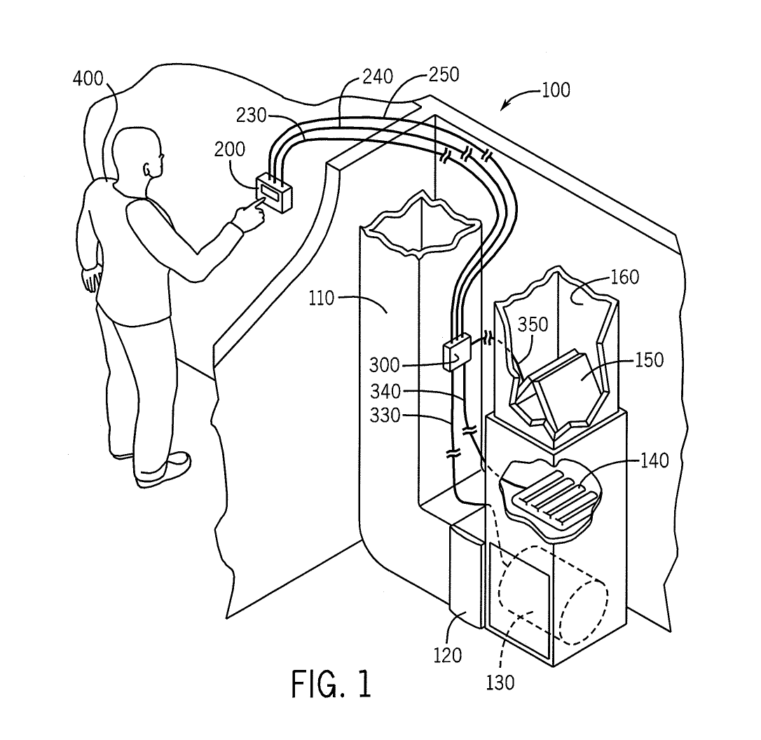

Referring now to the Figures, FIG. 1 illustrates an example of an HVAC system 100 which may incorporate one or more examples of embodiments of a system for the adjustment of ambient air temperature in an environment to improve the short term comfort of a user. The HVAC system 100 may include a return duct 110 coupled to a blower 130. A conditioning unit 120 may be coupled to return duct 110 and provided between return duct 110 and blower 130. For example, as shown in FIG. 1, HVAC system 100 may include an air cleaning unit 120. In one or more examples of embodiments, the conditioning unit may include any suitable device adapted to condition air, including, but not limited to, an air filter, an air purifier, a humidifier, a dehumidifier, or any other known or future developed air cleaning, filtering, purification and/or conditioning device. In one or more examples of embodiments, the conditioning unit may be provided at any suitable location in association with the return duct and/or supply duct. Further, in one or more examples of embodiments, a plurality of conditioning units may be provided at any suitable location in association with the HVAC system.

Blower 130 may also be coupled to a heating unit 140 and/or a cooling unit 150. Heating unit 140 and/or cooling unit 150 may subsequently be coupled to a supply duct 160. The supply duct 160 generally provides handled and/or conditioned air to the environment regulated by HVAC system 100. It should be appreciated that handled air may include, but not be limited to, air provided for ventilation, cleaned air, or filtered air. It should also be appreciated that conditioned air may include, but not be limited to, air which is heated and/or air which is cooled.

HVAC system 100 may also include a thermostat 200 and associated control system. Thermostat 200 may be provided in the environment regulated by HVAC system 100. Thermostat 200 generally monitors the temperature conditions in the environment, may provide information regarding the HVAC system 100 to user 400, may receive HVAC system 100 control settings entered by user 400, and/or may store and/or execute control settings for HVAC system 100.

Thermostat 200 may be in communication with an HVAC controller 300. For example, thermostat 200 may include a blower call line 230, a heating unit call line 240, and/or a cooling unit call line 250. The blower call line 230, heating unit call line 240, and/or cooling unit call line 250 may couple thermostat 200 with HVAC controller 300. In addition, HVAC controller 300 may include a blower control line 330, a heating unit control line 340, and a cooling unit control line 350. The blower control line 330, heating unit control line 340, and cooling unit control line 350 may couple HVAC controller 300 with the respective blower 130, heating unit 140, and cooling unit 150. In one or more examples of embodiments, the blower call line, heating unit call line, cooling unit call line, blower control line, heating unit control line, and/or cooling unit control line may be any suitable communication medium to convey communication signals, including, but not limited to, wired, wireless, or any future developed suitable communication medium.

In operation and use of HVAC system 100, a blower activation signal will be provided to blower 130 through blower control line 330. The signal may originate from thermostat 200 and be carried to HVAC controller 300 by blower call line 230, or may originate from HVAC controller 300. Blower 130 will activate and pull return air through return duct 110. Return duct 110 provides air to be handled and/or conditioned by HVAC system 100. Return duct 110 is in communication with an air source, for example, but not limited to, air from the environment regulated by HVAC system 100 and/or air from an outside environment, such as from the outdoors. Generally, blower 130 pulls air into return duct 110 and subsequently through air cleaning unit 120. Blower 130 will then push the air through heating unit 140 and/or cooling unit 150, and into supply duct 160. The air is then pushed by blower 130 through supply duct 160 and into the environment regulated by HVAC system 100. HVAC system 100 will continue to handle air until blower 130 is signaled to deactivate. These steps provide an example of handling or cycling air about the environment regulated by HVAC system 100.

HVAC system 100 may also warm or heat the air of the environment regulated by HVAC system 100. In addition to the steps recited above, a heating unit activation signal may be provided to heating unit 140 through heating unit control line 340. The signal may originate from thermostat 200. For example, thermostat 200 may measure the ambient temperature of an environment controlled by HVAC system 100 and determine that the environment temperature is below a pre-defined temperature limit, and thus too cold. Thermostat 200 will send a heating unit activation call to HVAC control 300 through heating unit call line 240. HVAC control 300 will subsequently transmit an associated heating unit activation signal to heating unit 140 through heating unit control line 340. Heating unit 140 will activate, increasing the temperature or warming the air pushed through heating unit 140 by blower 130. The warmer air will then be distributed into the environment regulated by HVAC system 100 via supply duct 160. HVAC system 100 will continue to warm or heat air until heating unit 140 is signaled to deactivate. In one or more examples of embodiments, the heating unit activation signal may originate from the HVAC control and be communicated to the heating unit through the heating unit control line.

HVAC system 100 may also chill or cool the air of the environment regulated by HVAC system 100. In addition to the steps recited above in association with handling or cycling air, a cooling unit activation signal may be provided to cooling unit 150 through cooling unit control line 350. The signal may originate from thermostat 200. For example, thermostat 200 may measure the ambient temperature of an environment controlled by HVAC system 100 and determine that the environment temperature is above a pre-defined temperature limit, and thus too warm. Thermostat 200 will send a cooling unit activation call to HVAC control 300 through cooling unit call line 250. HVAC control 300 will subsequently transmit an associated cooling unit activation signal to cooling unit 150 through cooling unit control line 350. Cooling unit 150 will activate, decreasing the temperature or cooling the air pushed through cooling unit 150 by blower 130. The cooler air will then be distributed into the environment regulated by HVAC system 100 via supply duct 160. HVAC system 100 will continue to chill or cool air until cooling unit 150 is signaled to deactivate. In one or more examples of embodiments, the cooling unit activation signal may originate from the HVAC control and be communicated to the cooling unit through the cooling unit control line.

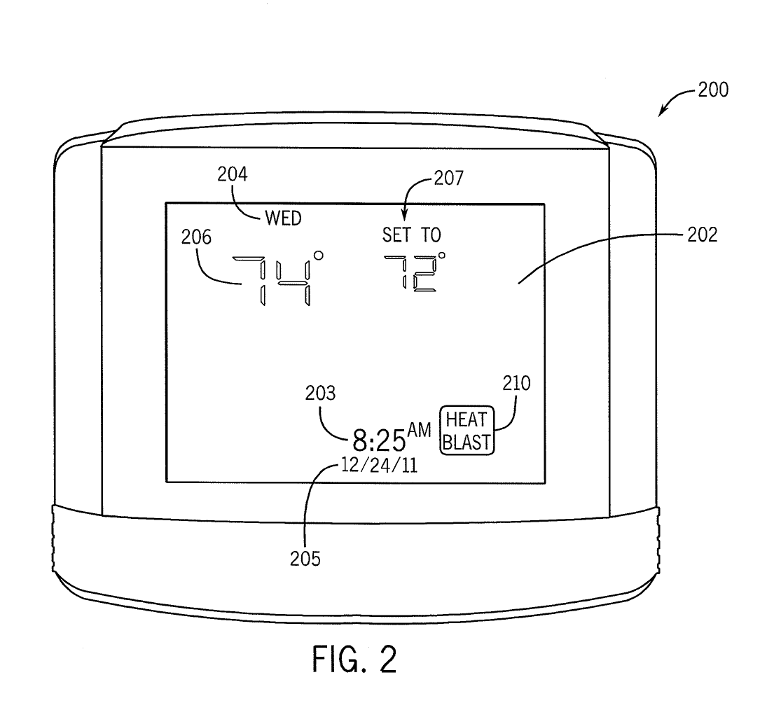

FIG. 2 illustrates an example of an embodiment of thermostat 200 for use with HVAC system 100 of FIG. 1. Thermostat 200 may include a user interface or interface or screen 202, such as the illustrated interactive LCD touch screen. Interface 202 may provide certain information, including, but not limited to, a present preset time 203, a present preset day of the week 204, a present preset date 205, a present measured temperature 206 of an environment controlled by HVAC system 100, and/or a present temperature set point 207 of an environment controlled by HVAC system 100. In one or more examples of embodiments, the interface may be any device which provides information, including, but not limited to an LCD display, an electronic display or any other known or future developed display suitable for providing information.

Thermostat 200 may also include program execution button or switch or blast button 210. Blast button 210 may be a user actuated button provided on the LCD touch screen to activate an HVAC control program which temporarily adjusts the ambient temperature of an environment to improve the short term comfort of the user. By interacting with blast button 210, a user may implement one touch operation of the associated HVAC control program. As shown in FIG. 2, blast button 210 is labeled “heat blast.” Accordingly, blast button 210 of FIG. 2 is associated with an HVAC control program which temporarily increases or raises the ambient temperature of an environment to improve the short term comfort of the user. In other words, blast button 210 provides heat to the targeted environment. It should be appreciated that in one or more examples of embodiments, the thermostat may include a blast button which is labeled “cool blast,” which is associated with an HVAC control program which temporarily decreases or lowers the ambient temperature of an environment to improve the short term comfort of the user. In other words, the “cool blast” button cools the targeted environment. Further, in one or more examples of embodiments, the thermostat may include two separate blast buttons, one button directed to a “heat blast” and one button directed to a “cool blast” as substantially described herein. In addition, in one or more examples of embodiment, the thermostat may include a single blast button which may be directed to one or both a “heat blast” and/or a “cool blast” as substantially described herein. For example, an HVAC control program may include predetermined logic in which a single blast button may initiate a heat blast or cool blast. The predetermined logic may be in communication with the control event in place when the blast button is actuated, such that the HVAC control program may recognize to implement a heat blast or a cool blast based upon control event settings or the last system call (call for heating or call for cooling) In one or more examples of embodiments, the blast button may be a mechanical button, or any other known or future developed button or switch suitable for activating the HVAC control program as described herein.

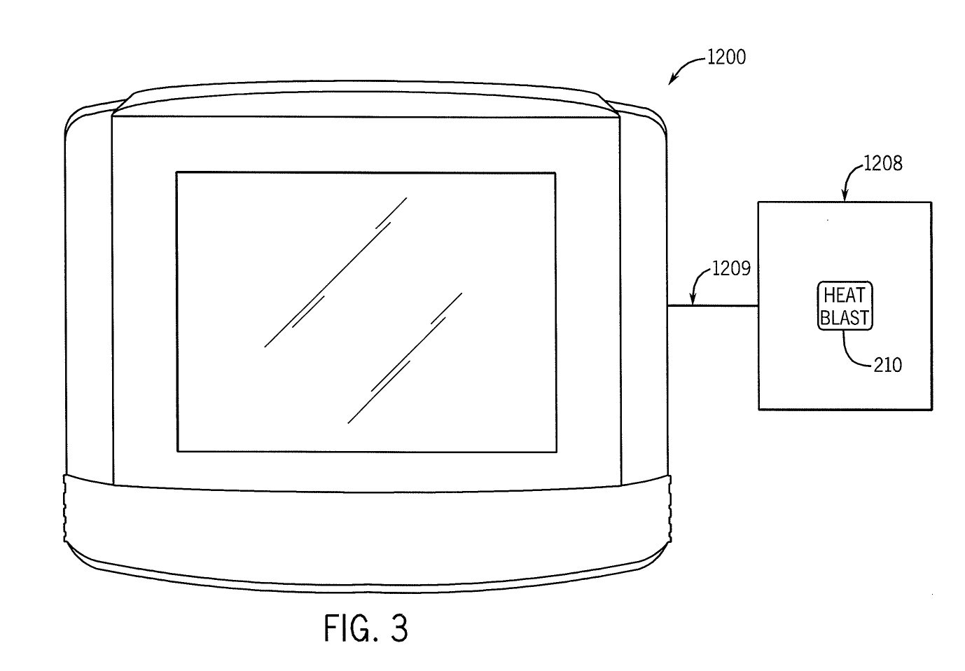

An alternative embodiment of thermostat 1200 is illustrated in FIG. 3. The thermostat 1200 includes features which are substantially as described herein in association with thermostat 200. Operation and particular components described herein are substantially the same and like numbers have been used to illustrate the like components. Referring to FIG. 3, in this embodiment, a controller 1208 may be coupled to thermostat 1200 by a communication link 1209. Controller 1208 may include the HVAC control program which temporarily adjusts the ambient temperature of an environment to improve the short term comfort of the user. In addition, controller 1208 may include button 210, which when actuated by a user, activates the associated HVAC control program. Communication link 1209 may provide communication between controller 1208 and thermostat 1200. For example, present temperature set point 207 may be communicated from thermostat 1200 to controller 1208 by communication link 1209. In another example, the HVAC control program and/or length of time of operation of the HVAC control program may be communicated from controller 1208 to thermostat 1200 by communication link 1209. In one or more examples of embodiments, the communication link may be any device which allows for the transmission or receipt of information or signals, including, but not limited to, a hardwired or wireless device suitable for the purpose as substantially described herein.

The foregoing presents one or more examples of embodiments of HVAC system 100. HVAC system 100 may also include one or more embodiments of an HVAC control program or application 500, 600 to improve the short term comfort of a user by providing a change in temperature (an increase in temperature or a decrease in temperature) for a period of time in an environment. The HVAC control program 500, 600 may be provided on a machine-readable or computer-readable medium. In addition, HVAC control program 500, 600 may reside as a program module which may be stored and/or operated on thermostat 200, 1200. The HVAC control program 500, 600 may be prepared or written in any suitable programming language which enables communication with and/or control of HVAC system 100. The steps recited in association with HVAC control program 500, 600 may reside or be stored as one or more instructions or program parameters executable by thermostat 200, 1200 and/or controller 1208.

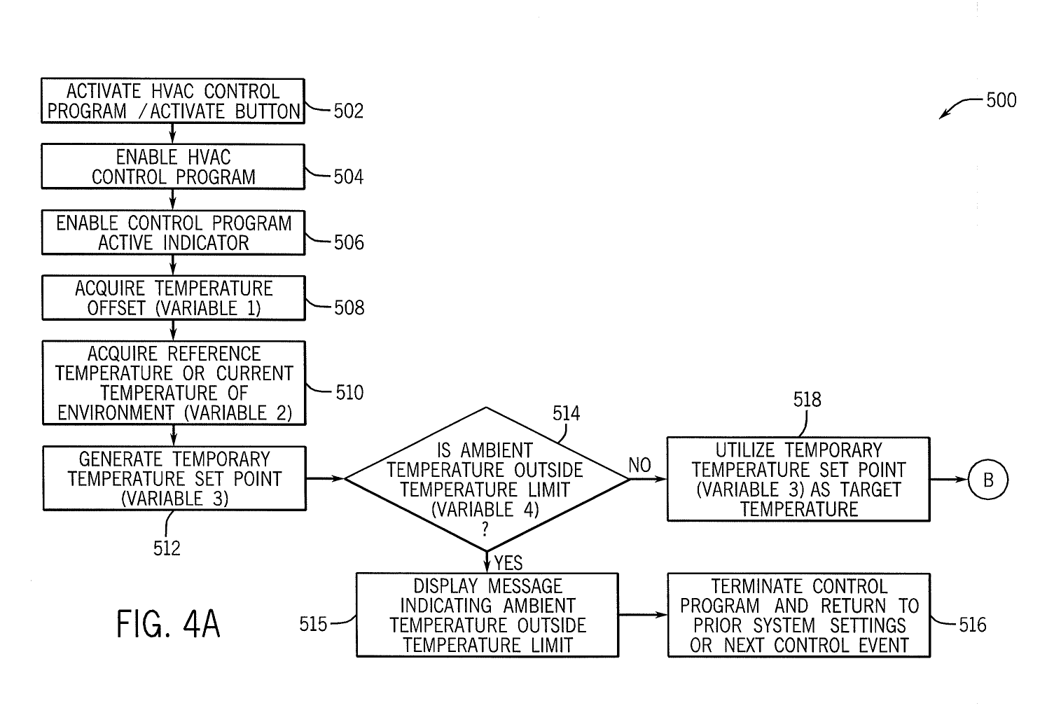

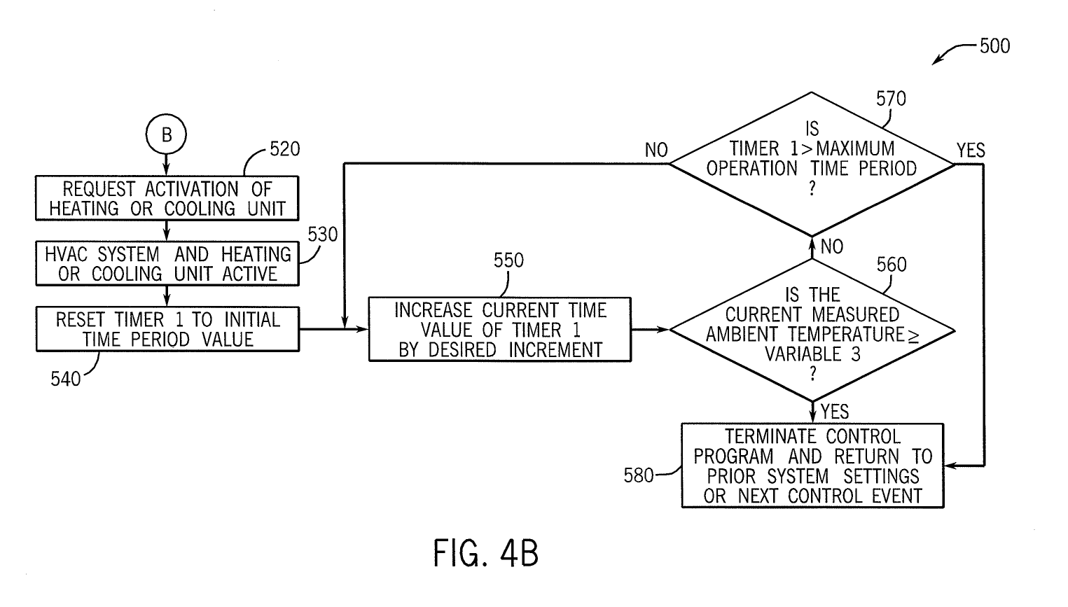

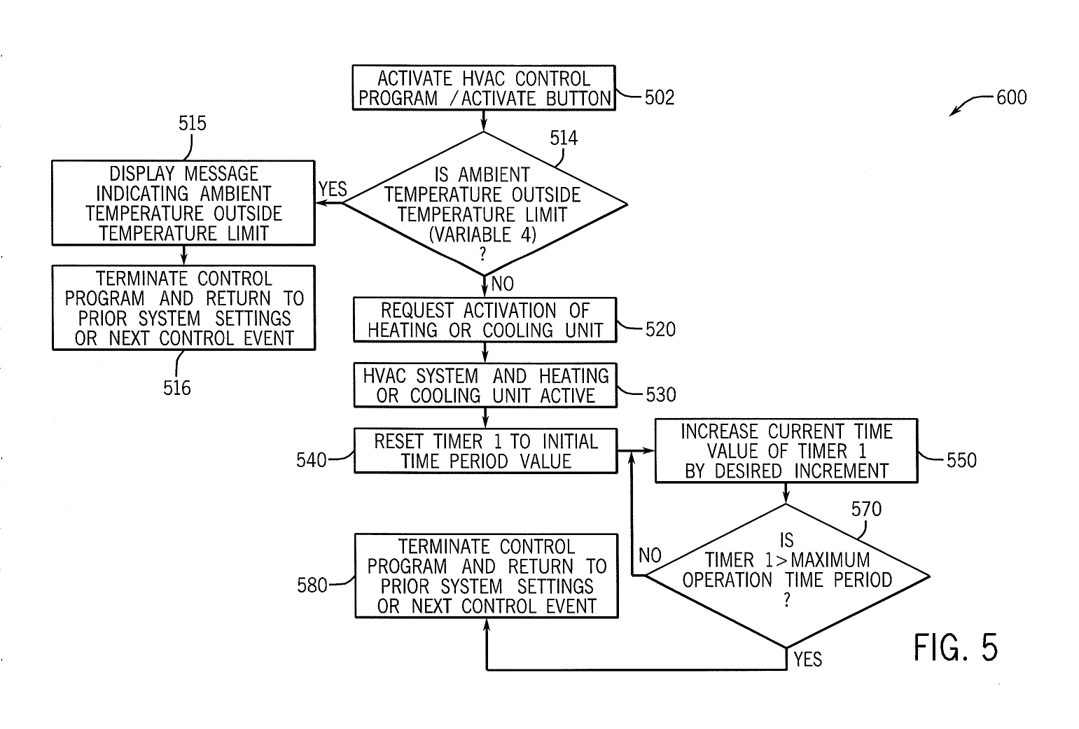

Referring to FIGS. 4A, 4B, and 5, the respective HVAC control program 500, 600 includes a series of steps or processing instructions which are depicted in flow chart or flow diagram form. HVAC control program 500, 600 may be implemented on a controller in association with HVAC system 100, for example, but not limited to, thermostat 200, 1200 or controller 1208.

FIG. 4A and 4B illustrates an example of an embodiment of HVAC control program 500. HVAC control program 500 may improve the short term comfort of a user by providing a temporary change in temperature of an environment regulated by HVAC system 100 by establishing a temporary temperature set point. The temporary temperature set point may target an increase in temperature (heating) or a decrease in temperature (cooling) in the environment. HVAC system 100 may operate until reaching the temporary temperature set point, providing improvement to the short term comfort of the user. In addition to, or optionally, HVAC system 100 may operate for a certain amount of time, providing improvement to the short term comfort of the user. After completion of control program 500, the thermostat 200, 1200 will return to the system setting at the time control program 500 is initiated or to the next scheduled event or program on the system.

Referring to FIG. 4A, at step 502 HVAC control program 500 is activated. Control program 500 may be activated by a user actuating or pressing program execution button or “blast” button 210. For example, a user may actuate button 210 on thermostat 200. The button actuated may be the button associated with the “heat blast” or the “cool blast.” Control program 500 may be initiated through one touch operation of blast button 210. In one or more examples of embodiment, control program 500 may be initiated through any suitable activation system. For example, a user may manually increase or decrease a temperature set point on a thermostat. After the desired manual temperature set point is reached, the thermostat may prompt the user to place the manual temperature set point into a hold, or to implement a “blast.” By selected a “blast,” one or more of the steps of control program 500 may be implemented.

Next, at step 504 control program 500 may be set to “enabled,” initiating the steps of control program 500. For example, a variable may be set to “enabled” or “on” upon actuation of button 210, indicating to thermostat 200, 1200 and/or controller 1208 to initiate operation of control program 500.

At step 506, an indicator may be enabled to provide notification that control program 500 is active. For example, thermostat 200, 1200 may remove a majority or all information presented on screen 202, but for button 210. In addition or optionally, screen 202 may include or display certain terms or characters, such as “heat blast active” or “cool blast active” or any other message associated with activation of control program 500. In addition or optionally, button 210 may be highlighted, darkened or lightened, indicating operation. In one or more examples of embodiments, any suitable indicator may be provided to provide notification of activation or operation of control program 500.

Next, at step 508, control program 500 acquires a temperature offset or blast offset. The temperature offset generally is a predetermined number of degrees Fahrenheit in which control program 500 uses to develop a temporary target temperature set point. Generally, the temperature offset may be stored locally, for example on thermostat 200, 1200 or controller 1208. The temperature offset may be stored as a first variable, Variable 1. The temperature offset may be a value which is preprogrammed by a user 400. For example, a user 400 may select a temperature offset from a predetermined range of temperatures, preferably in the range of one to twenty degrees Fahrenheit, more preferably in the range of one to ten degrees Fahrenheit, and further more preferably in the range of three to five degrees Fahrenheit. User 400 may select the temperature offset through thermostat 200, 1200 or controller 1208. The temperature offset may be stored as a positive number or a negative number. For example, a positive temperature offset number may be used in association with a heat blast, while a negative temperature offset number may be used in association with a cool blast. It should be appreciated that in one or more examples of embodiments, the temperature offset may be a positive number used in association with a heat blast and cool blast, or a negative number used in association with a heat blast and cool blast. In one or more examples of embodiments, the temperature offset may be a constant value which is preprogrammed and stored in association with control program 500. Further, in one of more examples of embodiments, the temperature offset may be any suitable range of temperatures in degrees Fahrenheit or Celsius.

At step 510, control program 500 may acquire a reference temperature. For example, as shown in FIG. 4A, the reference temperature may be the present ambient temperature of an environment regulated by HVAC system 100. The present ambient temperature may be measured by, displayed by, and/or stored by thermostat 200, 1200. The present ambient temperature may be stored as a second variable, Variable 2. In one or more examples of embodiments, the reference temperature may be a preset temperature, predetermined temperature, or the thermostat temperature set point at the implementation of control program 500.

Next, at step 512, control program 500 may generate a temporary temperature set point. The temporary temperature set point is the temperature in which control program 500 will target to adjust the ambient temperature of an environment to improve the short term comfort of user 400. Control program 500 may take the reference temperature or present ambient temperature (Variable 2) and apply the temperature offset (Variable 1) to calculate the temporary temperature set point. The temporary temperature set point may be stored as a third variable, Variable 3.

At step 514, control program 500 may determine if the present ambient temperature is outside of or within a certain HVAC operation temperature limit. The certain temperature limit may be a predetermined limit in which the HVAC system 100 may not operate due to environment, equipment, or system safety. The certain temperature limit may be stored as a fourth variable, Variable 4. For example, the heat cycle may have a temperature limit of 85° F. (eighty-five degrees Fahrenheit). Control program 500 will not operate the heating cycle if the ambient temperature is greater than, or optionally greater than or equal to, the temperature limit. As such, an example of the analysis at step 514 may be to determine if Variable 2 is equal to or greater than Variable 4. As another example, the cooling cycle may have a temperature limit of 40° F. (forty degrees Fahrenheit). Control program 500 will not operate the cooling cycle if the ambient temperature is less than, or optionally less than or equal to, the temperature limit. As such, an example of the analysis at step 514 may be to determine if Variable 2 is equal to or less than Variable 4. In one or more examples of embodiments, control program 500 may optionally, or in addition to step 514, determine if the temporary temperature set point, Variable 3, is outside of the temperature limit, Variable 4. For example, in association with a heat blast request, control program may determine whether Variable 3 is not greater than, or not greater than or equal to, Variable 4 (Variable 3>Variable 4). As another example, in association with a cool blast request, control program may determine if Variable 3 is not less than, or not less than or equal to, Variable 4 (Variable 3<Variable 4). In addition, in one or more examples of embodiments, control program 500 may optionally determine if the present ambient temperature and/or the temporary temperature set point is not outside of a certain temperature limit. In one or more examples of embodiments, the HVAC operation temperature limit may be a range of operational temperatures. Accordingly, at step 514 the program 500 may optionally determine whether the present ambient temperature and/or the temporary temperature set point is within the range of operational temperature limits. For example, the range of operational temperature limits may preferably be 50° F. (fifty degrees Fahrenheit) to 85° F. (eighty-five degrees Fahrenheit). It should be appreciated that the range of operational temperature limits may extend between any suitable or desired temperatures.

If control program 500 determines that, “yes,” the present ambient temperature (and/or temporary temperature set point) is outside of a certain temperature limit, at step 515 the control program 500 may present or display a message indicating the ambient temperature is outside of the temperature limit. For example, a message may display on screen 202 of thermostat 200, 1200. An example of a message for exceeding the heat cycle temperature limit may include “Max Heat Blast Temp Exceeded.” An example of a message for exceeding the cooling cycle temperature limit may include “Min Cool Blast Temp Exceeded.” At step 516, control program 500 will terminate and HVAC system 100 and/or thermostat 200, 1200 will return to the system settings and/or program in place when control program 500 was initiated. In the alternative, if the next control event for HVAC system 100 and/or thermostat 200, 1200 was scheduled to be implemented after initiation of control program 500 but before termination of program 500 at step 516, HVAC system 100 and/or thermostat 200, 1200 will implement the next control event upon termination of control program 500. As such, HVAC system 100 may stage down or deactivate at step 516.

If control program 500 determines that, “no,” the present ambient temperature (and/or temporary temperature set point) is not outside of a certain temperature limit, control program 500 will proceed to step 518. At step 518, control program 500 may utilize temporary temperature set point (Variable 3) as the target temperature for thermostat 200, 1200.

Referring to FIG. 4B, at step 520, HVAC control program 500 may request activation of heating unit 140 or cooling unit 150. For example, in association with a “heat blast,” control program 500 may transmit a heating call to heating unit 140 by heating unit call line 240 and/or heating unit control line 340. As another example, in association with a “cool blast,” control program 500 may transmit a cooling call to cooling unit 150 by cooling unit call line 250 and/or cooling unit control line 350. It should be appreciated that other equipment of HVAC system 100 necessary to distribute heated or cooled air may activate in association with the request for activation of heating unit 140 or cooling unit 150 at step 520. This may include, but is not limited to, activation of blower 130. At step 530, HVAC system 100 and the associated heating unit 140 or cooling unit 150 is active. It should be appreciated that at step 530, HVAC system 100, and associated heating unit 140 or cooling unit 150 may be operating at maximum output or the highest operational stage. In one or more examples of embodiments, HVAC system 100, and associated heating unit 140 or cooling unit 150 may be operating at any suitable or desired output or operational stage

Next, at step 540, a timer, Timer 1, may be reset to an initial time period value. Timer 1 represents the measured length of time of operation of HVAC system 100 during an associated “heat blast” or “cool blast” implemented by control program 500. Timer 1 may be used to ensure HVAC system 100 operates for a certain period of time, and does not operate indefinitely and/or does operate for a minimum amount of time. As illustrated in FIG. 4B, Timer 1 may be a “count-up” timer. Accordingly, Timer 1 may be reset to zero at step 540. In one or more examples of embodiments, Timer 1 may be a “count-down” timer which is reset to a predetermined amount of time at step 540.

At step 550, the current time period value held by Timer 1 may be increased or incremented by a desired time increment. A desired time increment may be one second, thirty seconds, one minute, or any desired amount of seconds and/or minutes. In one or more examples of embodiments, Timer 1 may be decreased or decremented by a desired time increment in association with a “count-down” timer.

At step 560, control program 500 determines if the currently measured or adjusted ambient temperature of the environment regulated by HVAC system 100 is greater than or equal to the temporary temperature set point, Variable 3. This determination ascertains whether the adjusted ambient temperature of the environment regulated by HVAC system 100 has been adequately changed to improve the short term comfort of user 400. It should be appreciated that step 560 of FIG. 4B illustrates a determination in association with “heat blast.” In one or more examples of embodiments, in association with “cool blast,” step 560 determines if the current measured ambient temperature of the environment regulated by HVAC system 100 is less than or equal to the temporary temperature set point, Variable 3.

If the determination in step 560 is yes, the adjusted ambient temperature of the environment is equal to, or greater than, the temporary temperature set point stored in Variable 3, control program 500 moves to step 580. If the determination in step 560 is no, the adjusted ambient temperature of the environment is not equal to, or not greater than, the temporary temperature set point stored in Variable 3, control program 500 moves to step 570.

At step 570, control program 500 determines if the current time value stored in Timer 1 is greater than or exceeds a predetermined maximum operation time period. The maximum operation time period may be a preset or predetermined amount of time which is kept constant. For example, the predetermined maximum operation time period may be sixty minutes. Step 570 provides a limited or capped amount of HVAC system 100 operation time should the measured ambient temperature of the environment not equal (or go beyond) the temporary temperature set point stored in Variable 3. In one or more examples of embodiments, the predetermined maximum operation time period may be any desired amount of time. In addition, in one or more examples of embodiments, when Timer 1 is a count-down timer, the predetermined maximum operation time period may be preset to zero.

If the determination at step 570 is no, the current time value stored in Timer 1 is not greater than the predetermined maximum operation time period, control program 500 returns to step 550. Steps 550, 560 and 570 may subsequently repeat until either the current measured ambient temperature is (for “heat blast”) greater than or equal to, or (for “cool blast”) less than or equal to, the temporary temperature set point stored in Variable 3, or Timer 1 is outside a predetermined maximum operation time period (Timer 1≧Time Period for “count-up” timer, or Timer 1≦Time Period for “count-down” timer). If the determination at step 570 is yes, the current time value stored in Timer 1 is greater than the predetermined maximum operation time period, control program 500 moves to step 580.

At step 580, control program 500 will end or terminate and HVAC system 100 and/or thermostat 200, 1200 will return to the system settings and/or program in place when control program 500 was initiated. In the alternative, if the next control event for HVAC system 100 and/or thermostat 200, 1200 was scheduled to be implemented after initiation of control program 500 but before termination of program 500 at step 580, HVAC system 100 and/or thermostat 200, 1200 will implement the next control event. As such, HVAC system 100 may stage down or deactivate. It should be appreciated that HVAC system 100 may continue operation if the returned to system settings, returned to program in place, and/or next control event necessitates additional operation of HVAC system 100.

In one or more examples of embodiments, control program 500 may optionally exclude steps 540, 550, and 570. In this embodiment, step 530 will proceed to step 560. Accordingly, control program 500 will continue until the current measured ambient temperature is greater than or equal to the temporary temperature set point stored in Variable 3

It should be appreciated that control program 500 may be manually terminated at any time, for example by actuating a button on thermostat 200, 1200 interlocked to terminate control program 500. This may include, but is not limited to, actuating “blast” button 210, or actuating a cancel button (not shown) or set point button (not shown) on thermostat 200, 1200 and/or controller 1208.

FIG. 5 illustrates an example of an alternative embodiment of HVAC control program 600. Control program 600 includes features which are substantially as described herein in association with control program 500. Operation and particular components or steps described herein are substantially the same and like numbers have been used to illustrate the like components or steps. HVAC control program 600 may improve the short term comfort of a user by providing a temporary change in temperature of an environment regulated by HVAC system 100 by operating HVAC system 100 for a preset amount of time. The temporary temperature change may be an increase in temperature (heating) or a decrease in temperature (cooling) in the environment.

Referring to FIG. 5, control program 600 may include step 502, in which a user 400 activates HVAC control program 600 and/or actuates button 210. Next, control program 600 may proceed to step 514, where a determination is made as to whether the ambient temperature of the environment is outside of a temperature limit. If yes, the ambient temperature is outside of a temperature limit, control program 600 may proceed to step 515 to display a message indicating the ambient temperature is outside the temperature limit, and/or step 516, where control program 600 may terminate and return to prior system setting or the next control event. If no, the ambient temperature is not outside of a temperature limit, control program 600 may proceed to step 520 to request activation of heating unit 140 or cooling unit 150, and step 530 where HVAC system 100 and either heating unit 140 or cooling unit 150 is activate or operating. It should be appreciated that at step 530, HVAC system 100 and either heating unit 140 or cooling unit 150 may be operating at maximum output. However, in one or more examples of embodiments, HVAC system 100 and either heating unit 140 or cooling unit 150 may be operating at any desired level of output.

Next, at step 540, Timer 1 may be reset to an initial time period value. If Timer 1 is a count-up timer, the initial time period value may be set to zero. If Timer 1 is a count-down timer, the initial time period value may be any preset or preselected amount of time. For example, Timer 1 may be preset to sixty minutes. In one or more examples of embodiments, Timer 1 may be preset or reset to any suitable amount of time, whether a positive or negative number, in association with a count-up or count-down timer.

At step 550, the current time value stored in Timer 1 may be adjusted by a desired increment. For example, if Timer 1 is a count-up timer, the current time value may be adjusted up or increased by the desired increment. As another example, if Timer 1 is a count-down timer, the current time value may be adjusted down or decreased by the desired increment. In one or more examples of embodiments, the desired increment may be one or more seconds, one or more minutes, or any other suitable or desired amount of time.

Next, at step 570, control program 600 determines if the current time value stored in Timer 1 is outside of a predetermined operation time period. For example, when Timer 1 is a count-up timer, the predetermined operation time period may be a preset or predetermined operation time period, such as, but not limited to, twenty minutes. The predetermined operation time period may be any suitable amount of time in hours, minutes, or seconds, positive or negative, or a combination thereof. Thus, at step 570, control program determines if the current time value stored in Timer 1 is greater than, or greater than or equal to, the predetermined operation time period. If no, the current time value stored in Timer 1 is not greater than the predetermined operation time period, control program 600 returns to step 550. If yes, the current time value stored in Timer 1 is greater than the predetermined operation time period, control program 600 moves to step 580.

In another example of step 570, when Timer 1 is a count-down timer, the predetermined operation time period may be preset to zero. Thus, at step 570, control program determines if the current time value stored in Timer 1 is less than, or less than or equal to, the predetermined operation time period. If no, the current time value stored in Timer 1 is not less than or equal to the predetermined operation time period, control program 600 returns to step 550. If yes, the current time value stored in Timer 1 is less than or equal to the predetermined operation time period, control program 600 moves to step 580.

At step 580, control program 600 will end or terminate and HVAC system 100 and/or thermostat 200, 1200 will return to the system settings and/or program in place when control program 600 was initiated. In the alternative, if the next control event for HVAC system 100 and/or thermostat 200, 1200 was scheduled to be implemented after initiation of control program 600 but before termination of program 600 at step 580, HVAC system 100 and/or thermostat 200, 1200 will implement the next control event. As such, HVAC system 100 may stage down or deactivate. It should be appreciated that HVAC system 100 may continue operation if the returned to system settings, returned to program in place, and/or next control event necessitates additional operation of HVAC system 100.

It should be appreciated that in association with control program 600, steps 502, 514, 515, 516, 520, 530, 540, 550, 570, and/or 580 are substantially as described in association with control program 500.

It should be appreciated that control program 500, 600 may operate independently of and/or in conjunction with other HVAC control programs, for example control programs residing on thermostat 200, 1200. Accordingly, other HVAC control programs may continue to operate during operation of control program 500, 600. For example, one or more HVAC control programs may continue to operate, however their respective ability to control or signal HVAC system 100 may be temporarily suspended and/or replaced by control program 500, 600. As such, control program 500, 600 may provide a temporary adjustment of the ambient temperature of an environment regulated by HVAC system 100, and upon completion, termination or ending of control program 500, 600, may allow thermostat 200, 1200 to automatically revert to the other HVAC control program operating or scheduled to operate in association with thermostat 200, 1200. It should also be appreciated that other HVAC control programs and control program 500, 600 may share information and/or data to sufficiently control or operate HVAC system 100. An example of other HVAC control programs may include the programs disclosed, described, and claimed in U.S. patent application Ser. No. 12/353,852, the contents of which is hereby incorporated by reference in its entirety.

In operation and use of control program 500, a user 400 may choose to select a “heat blast” or “cool blast” to temporarily adjust the ambient temperature of an environment to improve the short term comfort of user 400. User 400 will actuate “blast” button 210 associated with the heat or cool “blast” (at step 502 of FIG. 4A). This activates control program 500 (at step 504 of FIG. 4A). An indicator may be presented on thermostat 200, 1200 indicating the heat or cool “blast” is active (at step 506 of FIG. 4A). Control program 500 will generate an associated temporary temperature set point (at steps 508, 510, 512 of FIG. 4A), verify the ambient temperature and/or temporary temperature set point is within certain temperature limits (at step 514 of FIG. 4A), and implement the temporary temperature set point on thermostat 200, 1200 (at step 518 of FIG. 4A). Thermostat 200, 1200 may request activation of HVAC system 100 and the associated heating or cooling unit 140, 150 (at steps 520, 530 of FIG. 4B). HVAC system 100 will then heat or cool the ambient temperature of an environment to improve the short term comfort of user 400 until control program 500 terminates (by user intervention) or ends (through instructions executed by control program 500). Control program 500 may end when the measured ambient temperature of the environment, which may be measured by thermostat 200, 1200, equals the temporary temperature set point (at step 560 of FIG. 4B). Control program 500 may also end when the HVAC system run timer, tracked and stored in Timer 1, equals a preset HVAC system operation time period (at steps 540, 550, 570 of FIG. 4B). When control program 500 terminates or ends, either by user intervention or completion of program 500, thermostat 200, 1200 automatically returns to the target temperature or HVAC control program operating or scheduled to operate with thermostat 200, 1200 at the time control program 500 terminates or ends (at step 580 of FIG. 4B).

To further illustrate operation and use of control program 500, the following provides an example of certain operational scenarios using certain system conditions. The scenarios and associated system conditions are provided for example only, and are not meant to be limiting in any way. Any number or combination of scenarios or system conditions may be realized in association with an HVAC system 100 and/or environment regulated by an HVAC system 100.

As an example of a “heat blast” scenario, the system may have the following hypothetical system conditions: the current temperature of the environment regulated by HVAC system 100 may be 72° F. (seventy-two degrees Fahrenheit), the “blast” offset (Variable 1) may be 6° (six degrees), the maximum heat set point or temperature limit (Variable 4) may be 85° F. (eighty-five degrees Fahrenheit), the desired increment to increase Timer 1 may be one second, and the maximum operation time period of the HVAC system may be sixty minutes.

User 400 may begin use by activating the “blast button” (at step 502 of FIG. 4A) which begins operation of control program 500. Control program 500 may then proceed through one or more of the disclosed process steps of control program 500, including generation of a temporary heat set point (at step 512 of FIG. 4A). The temporary heat set point may be generated by combining the current environment temperature with the “blast” offset. Based upon the hypothetical conditions, the temporary heat set point would be 78° F. (seventy-eight degrees Fahrenheit), calculated by adding 72° F. plus 6° F. The temporary heat set point of 78° F. may be stored as Variable 3.

Control program 500 may then analyze the current temperature to determine if it is within the maximum heat set point (at step 514 of FIG. 4A). Based upon the hypothetical conditions, the current temperature of 72° F. would not be outside the maximum heat set point of 85° F., calculated by determining “is 72° F.>85° F?” Since the determination is “no,” program 500 may proceed to utilizing the temporary heat set point, implementing the temporary heat set point as the target temperature in thermostat 200, 1200 (at step 518 of FIG. 4A).

Control program 500 may then proceed through one or more of the disclosed process steps of control program 500, including activation of blower 130 and heating unit 140 (at step 530 of FIG. 4B). Control program 500 may implement a timer which correlates with the operational time of HVAC system 100 following activation of program 500. Timer 1 may be reset to an initial time period, for example zero (at step 540 of FIG. 4B). Timer 1 may then be increased by the desired increment, or one second based upon the hypothetical conditions, and save the increased time in Timer 1 (at step 550 of FIG. 4B). Program 500 may then determine whether Timer 1 exceeds the maximum operation time period of the HVAC system (at step 570 of FIG. 4B). Based upon the hypothetical conditions, the determination is calculated by determining “is Timer 1>sixty minutes?”

Control program 500 may also determine if the ambient temperature of the environment, which may be measured by thermostat 200, 1200, is equal to or exceeds the temporary heat set point (at step 560 of FIG. 4B). Based upon the hypothetical conditions, the determination is calculated by determining “is the current ambient temperature of the environment ≧78° F?”

Steps 550, 560, 570 may repeat until the ambient temperature equals or exceeds the temporary heat set point (determine “yes” for step 560), Timer 1 exceeds the maximum operation time period (determine “yes” for step 570), or user 400 manually cancels program 500. If either steps 560 or 570 results in a “yes” determination, the “heat blast” will be complete. Program 500 may restore the previous temperature set point or the scheduled control program (at step 580 of FIG. 4B). In addition, program 500 may stage down the HVAC system 100 and associated blower 130 and heating unit 140. Program 500 will then end or terminate.

As an example of a “cool blast” scenario, the system may have the following hypothetical system conditions: the current temperature of the environment regulated by HVAC system 100 may be 74° F. (seventy-four degrees Fahrenheit), the “blast” offset (Variable 1) may be 6° (six degrees), the minimum cool set point or temperature limit (Variable 4) may be 60° F. (sixty degrees Fahrenheit), the desired increment to increase Timer 1 may be one second, and the maximum operation time period of the HVAC system may be sixty minutes.

User 400 may begin use by activating the “blast button” (at step 502 of FIG. 4A) which begins operation of control program 500. Control program 500 may then proceed through one or more of the disclosed process steps of control program 500, including generation of a temporary cooling set point (at step 512 of FIG. 4A). The temporary cooling set point may be generated by combining the current environment temperature with the “blast” offset. Based upon the hypothetical conditions, the temporary cooling set point would be 68° F. (sixty-eight degrees Fahrenheit), calculated by subtracting 6° F. from 74° F. The temporary cooling set point of 68° F. may be stored as Variable 3.

Control program 500 may then analyze the current temperature to determine if it is within the minimum cooling set point (at step 514 of FIG. 4A). Based upon the hypothetical conditions, the current temperature of 74° F. would not be outside the minimum cooling set point of 60° F., calculated by determining “is 74° F. <60° F.?” Since the determination is “no,” program 500 may proceed to utilizing the temporary cooling set point, implementing the temporary cooling set point as the target temperature in thermostat 200, 1200 (at step 518 of FIG. 4A).

Control program 500 may then proceed through one or more of the disclosed process steps of control program 500, including activation of blower 130 and cooling unit 150 (at step 530 of FIG. 4B). Control program 500 may implement a timer which correlates with the operational time of HVAC system 100 following activation of program 500. Timer 1 may be reset to an initial time period, for example zero (at step 540 of FIG. 4B). Timer 1 may then be increased by the desired increment, or one second based upon the hypothetical conditions, and save the increased time in Timer 1 (at step 550 of FIG. 4B). Program 500 may then determine whether Timer 1 exceeds the maximum operation time period of the HVAC system (at step 570 of FIG. 4B). Based upon the hypothetical conditions, the determination is calculated by determining “is Timer 1>sixty minutes?”

Control program 500 may also determine if the ambient temperature of the environment, which may be measured by thermostat 200, 1200, is equal to or less than the temporary cooling set point (at step 560 of FIG. 4B). Based upon the hypothetical conditions, the determination is calculated by determining “is the current ambient temperature of the environment ≦68° F.?”

Steps 550, 560, 570 may repeat until the ambient temperature equals or is less than the temporary cooling set point (determine “yes” for step 560), Timer 1 exceeds the maximum operation time period (determine “yes” for step 570), or user 400 manually cancels program 500. If either steps 560 or 570 make a “yes” determination, the “cool blast” will be complete. Program 500 may restore the previous temperature set point or the scheduled control program (at step 580 of FIG. 4B). In addition, program 500 may stage down the HVAC system 100 and associated blower 130 and cooling unit 150. Program 500 will then end or terminate.

In operation and use of control program 600, a user 400 may choose to select a “heat blast” or “cool blast” to temporarily adjust the ambient temperature of an environment to improve the short term comfort of user 400. User 400 will actuate “blast” button 210 associated with the heat or cool “blast” (at step 502 of FIG. 5). Control program 600 may then proceed through one or more of the disclosed process steps of control program 600. Thermostat 200, 1200 may request activation of HVAC system 100 and the associated heating or cooling unit 140, 150 (at steps 520, 530 of FIG. 5). HVAC system 100 will then heat or cool the ambient temperature of an environment to improve the short term comfort of user 400 until control program 600 terminates (by user intervention) or ends (through instructions executed by control program 600). Control program 600 may end when the HVAC system run timer, tracked and stored in Timer 1, equals a preset HVAC system operation time period (at steps 540, 550, 570 of FIG. 5). When control program 600 terminates or ends, either by user intervention or completion of program 600, thermostat 200, 1200 automatically returns to the target temperature or HVAC control program operating or scheduled to operate with thermostat 200, 1200 at the time control program 600 terminates or ends (at step 580 of FIG. 5).

The foregoing embodiments of the HVAC system and HVAC control program provide advantages over currently available devices. The HVAC control program temporarily adjusts the ambient temperature of an environment to improve the short term comfort of the user. In addition, the control program may operate concurrently with existing control programs, settings, or control events, allowing the control program to revert or return to the prior or scheduled control events upon completion or termination of the control program. This further provides functionality where a user may execute the control program for a temporary improvement of short term comfort and walk away with the knowledge that once the control program completes, the previous control settings or events will be restored. It is not necessary for a user to reprogram or readjust the HVAC control system once the user has attained the desired short term comfort. In addition, the control program allows for an improvement in the short term comfort of a user without requiring reprogramming of HVAC control programs, including preexisting thermostat programs controlling the HVAC system. Further, the control program provides the temporary improvement of user short term comfort while avoiding the unnecessary consumption of energy, as the control program ends after satisfying certain preset criteria. In addition, the control program may provide one touch implementation, wherein a user may execute the program through actuation of a single button or switch. These and other advantages may be realized from one or more embodiments of the HVAC system and HVAC control program disclosed herein.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g., attached, coupled, connected) are to be construed broadly and may include intermediate members between a connection of elements and relative movement between elements. As such, joinder references do not necessarily infer that two elements are directly connected and in fixed relation to each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although various representative examples of embodiments of this invention have been described above with a certain degree of particularity, those skilled in the art could make numerous alterations to the disclosed embodiments without departing from the spirit or scope of the inventive subject matter set forth in the specification and claims. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Moreover, some portions of the detailed descriptions herein are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities. Unless specifically stated otherwise as apparent from the discussions herein, it is appreciated that throughout the present invention, discussions utilizing terms such as “receiving,” “sending,” “generating,” “reading,” “invoking,” “selecting,” and the like, refer to the action and processes of a computer system, or similar electronic computing device, including an embedded system, that manipulates and transforms data represented as physical (electronic) quantities within the computer system.

Although the present invention has been described with reference to particular embodiments, persons skilled in the art will recognize that changes may be made in form and detail without departing from the spirit and scope of the invention.

What is claimed is:

1. A method for temporarily adjusting an ambient temperature of an environment regulated by an HVAC system comprising:
activating a control program through actuation of a program execution switch;
interrupting a thermostat control event in place at the time of activating the control program;
generating a temporary temperature set point by combining a reference temperature with a temperature offset;
implementing the temporary temperature set point as a target temperature on the thermostat;
activating the HVAC system to heat or cool the environment;
measuring an adjusted ambient temperature in the environment regulated by the HVAC system through the thermostat;
determining whether the adjusted ambient temperature equals the temporary temperature set point;
repeating the step of measuring the adjusted ambient temperature and determining whether the adjusted ambient temperature equals the temporary temperature set point if the adjusted ambient temperature does not equal the temporary temperature set point; and
restoring the thermostat control event and terminating the method if the adjusted ambient temperature does equal the temporary temperature set point.

2. The method of claim 1, wherein the reference temperature in the generating step is the ambient temperature of the environment measured during the generating step.

3. The method of claim 1, wherein the temperature offset is stored on the thermostat.

4. The method of claim 1, wherein generating a temporary temperature set point further comprises:
determining whether the reference temperature is within an HVAC operation temperature limit; and
restoring the thermostat control event and terminating the method if the reference temperature is not within an HVAC operation temperature limit.

5. The method of claim 1, wherein the step of restoring the thermostat control event and terminating the method further comprises deactivating the HVAC system.

6. The method of claim 1, further comprising after the step of activating the HVAC system to heat or cool the environment:
determining if an amount of time in a timer exceeds a maximum operation time period;
increasing the amount of time remaining in a timer by a desired increment if the amount of time remaining in the timer does not exceed the maximum operation time period; and
restoring the thermostat control event and terminating the method if the amount of time remaining in the timer does exceed the maximum operation time period.

7. The method of claim 6, wherein:
the step of restoring the thermostat control event and terminating the method if the adjusted ambient temperature does equal the temporary temperature set point further comprises deactivating the HVAC system; and
the step of restoring the thermostat control event and terminating the method if the amount of time remaining in the timer does exceed the maximum operation time period further comprises deactivating the HVAC system.

8. The method of claim 1, further comprising after the step of activating the HVAC system to heat or cool the environment:
determining if an amount of time remaining in a timer is greater than zero;
reducing the amount of time remaining in a timer by a desired increment if the amount of time remaining in the timer is greater than zero; and
restoring the thermostat control event and terminating the method if the amount of time remaining in the timer is not greater than zero.

9. The method of claim 8, wherein:
the step of restoring the thermostat control event and terminating the method if the adjusted ambient temperature does equal the temporary temperature set point further comprises deactivating the HVAC system; and
the step of restoring the thermostat control event and terminating the method if the amount of time remaining in the timer is not greater than zero further comprises deactivating the HVAC system.

10. The method of claim 1, wherein the program execution switch in the step of activating the control program resides on the thermostat.

11. The method of claim 1, wherein the step of activating the HVAC system to heat or cool the environment further comprises operating the HVAC system at the highest stage of heating or cooling output.

12. The method of claim 1, wherein the thermostat control event during the step of interrupting a thermostat control event in place at the time of activating the control program is different than the thermostat control event during the step of restoring the thermostat control event and terminating the method if the adjusted ambient temperature does equal the temporary temperature set point.

13. A method for temporarily adjusting an ambient temperature of an environment regulated by an HVAC system comprising:
activating a control program through actuation of a program execution switch;
interrupting a thermostat control event in place at the time of activating the control program;
activating the HVAC system to heat or cool the environment;
determining if an amount of time remaining in a timer is greater than zero;
reducing the amount of time remaining in a timer by a desired increment if the amount of time remaining in the timer is greater than zero;
repeating the determining and reducing steps if the amount of time remaining in the timer is greater than zero; and
restoring the thermostat control event and terminating the method if the amount of time remaining in the timer is not greater than zero.

14. The method of claim 13, wherein the step of activating the HVAC system to heat or cool the environment further comprises operating the HVAC system at the highest stage of heating or cooling output.

15. The method of claim 13, wherein the program execution switch in the step of activating the control program resides on the thermostat.

16. The method of claim 13, wherein the step of restoring the thermostat control event and terminating the method further comprises deactivating the HVAC system.

17. A system for the temporary adjustment of ambient temperature in an environment to improve the short term comfort of a user comprising:
an HVAC system including a unit to condition air, the HVAC system in operable communication with the environment to provide conditioned air;
a thermostat in communication with the HVAC system, the thermostat adapted to measure the ambient temperature of the environment and to provide control instructions to the HVAC system;
a control module residing on the thermostat, the control module adapted to execute program parameters upon activation of a program execution button, the program parameters include:
a first program parameter adapted to interrupt a thermostat control event which is in place at the time of activation of the program execution button;
a second program parameter adapted to generate a temporary temperature set point by combining a reference temperature with a temperature offset;
a third program parameter adapted to implement the temporary temperature set point as a target temperature on the thermostat;
a fourth program parameter adapted to activate the HVAC system to heat or cool the environment;
a fifth program parameter adapted to measure an adjusted ambient temperature in the environment;
a sixth program parameter adapted to determine whether the adjusted ambient temperature equals the temporary temperature set point;
a seventh program parameter adapted to repeat the measurement of the adjusted ambient temperature in the environment and the determination as to whether the adjusted ambient temperature equals the temporary temperature set point if the adjusted ambient temperature does not equal the temporary temperature set point; and
an eighth program parameter adapted to restore the thermostat control event and terminate the program parameters if the adjusted ambient temperature does equal the temporary temperature set point.

18. The system of claim 17, wherein the reference temperature is the ambient temperature of the environment at the time of activation of the program execution button.

19. The system of claim 17, wherein the program parameters further comprise:
a ninth program parameter adapted determine if an amount of time remaining in a timer is greater than zero;
a tenth program parameter adapted to reduce the amount of time remaining in a timer by a desired increment if the amount of time remaining in the timer is greater than zero;
a eleventh program parameter adapted to repeat the tenth and eleventh program parameters if the amount of time remaining in the timer is greater than zero; and
a twelfth program parameter adapted to restore the thermostat control event and terminate the program parameters if the amount of time remaining in the timer is not greater than zero

20. The system of claim 19, wherein the eighth program parameter and twelfth program parameter each include deactivation of the HVAC system.
